(19) United States
(12) Patent Application Publication
(10) Pub. No.: US 2021/0209529 A1
(43) Pub. Date: Jul. 8, 2021

(54) SYSTEMS AND METHODS FOR OPTIMIZING AND MANAGING HIGH VOLUME PROCESSES HAVING DISCRETIZED AND ATOMIZED TASKS AND COMPONENTS

(71) Applicant: Michael W. Kane, Encino, CA (US)

(72) Inventor: Michael W. Kane, Encino, CA (US)

(21) Appl. No.: 17/134,152

(22) Filed: Dec. 24, 2020

Related U.S. Application Data
(63) Continuation of application No. 16/045,629, filed on Jul. 25, 2018, now abandoned.
(60) Provisional application No. 62/537,364, filed on Jul. 26, 2017.

(51) Int. Cl. G06Q 10/06; G06F 3/0481; H04L 29/06; H04L 12/24

(52) U.S. Cl. CPC G06Q 10/0633; G06Q 10/063112; G06Q 10/063114; H04L 67/42; H04L 41/22; G06F 3/0481

(57) ABSTRACT

Systems, methods, and devices for optimizing and managing high volume processes by atomizing the work into discrete elements, tasks and components and batching similar elements, and then tracking, pushing, gating, automating and monitoring in real time task element groupings for just-in-time assignment, and then reassembled into a finished product to which quality control standards are enforced uniformly throughout via a network, as elements and tasks are completed on network connected user devices.

### CROSS REFERENCE TO RELATED APPLICATION

This application is a continuation of U.S. patent application Ser. No. 16/045,629, filed Jul. 25, 2018, which claims priority to U.S. Provisional Patent Application No. 62/537,364, filed Jul. 26, 2017, the disclosures of each of which are hereby incorporated by reference in their entireties.

### FIELD OF THE INVENTION

The present disclosure relates generally to the field of optimizing and managing high volume processes having discretized and atomized tasks and components, and more particularly to systems and methods for optimizing and managing high volume processes having discretized and atomized tasks and components in professional services.

### BACKGROUND OF THE INVENTION

Organizations that provide professional services requiring licensure and accreditation generally do not serve very high volumes of customers with similar cases to resolve because the typical distribution of workload, work processes and hierarchical form of organization, create bottlenecks prohibitive of high volume throughput that meets or exceeds the relevant, and regulated, standards of practice. For example, it is neither prudent, nor economically feasible, to sell high volumes of contingent, fixed price, prepaid service plans requiring the contribution of licensed and accredited professionals to hundreds of thousands or millions of customers, hundreds or thousands of which are likely to need to invoke, many within similar time periods, the prepaid plans they purchased. Although consumers would benefit greatly from the significant cost decreases made possible by very high volume production of licensed, accredited, and high-quality professional services, the several existing attempts to solve the high-volume, high-quality challenge presented by those seeking to package and sell mass quantities of prepaid service plans rely on the brute force approach: delegating case work to geographically distributed individual practitioners under independent contractor arrangements difficult to monitor for quality because the professional status of the licensed practitioners permits them to approach cases idiosyncratically.

What is needed, therefore, is a solution that solves for very high-volume production that always meet standards of practice and competency without the above mentioned and other disadvantages.

As such, it would be beneficial to provide technical solutions for professional service organizations that provide prepaid, low-cost, memberships, particularly in the case of tax audit defense plans. This would provide auditees of the IRS time and cost savings, as well as better piece of mind from the threat of potentially unforeseen costs.

### SUMMARY OF THE INVENTION

Disclosed herein are systems, methods, and processes that provide technological solutions for optimizing and managing high volume processes having discretized and atomized tasks and components via a network by distributing, monitoring, receiving updates, and tracking individual case tasks and case task results, via the network, for a plurality of case files stored on a network connected organization management optimization server in real-time, as they are completed on network connected user devices.

In some embodiments, the present disclosure include systems, methods, and devices for optimizing and managing high volume processes by atomizing the work into discrete elements, tasks and components and batching similar elements, and then tracking, pushing, gating, automating and monitoring in real time workflow task element groupings to which appropriate knowledge-worker skill sets are matched and assigned just in time, and then reassembled into a finished product as to which quality control standards are enforced uniformly throughout via a network where case files are stored on a network connected organization management optimization server in real-time, as they are completed on network connected user devices.

In some embodiments, the present disclosures include systems, methods, and processes that provide technological solutions for improving professional services delivery models in terms of long term economic viability, scalability, and profitability, while minimizing or eliminating fundamental weaknesses. As such, they can deliver uniform service output of a consistent high quality that is also timely and profitable, despite fluctuations in case volume. These various contemplated embodiments provide systems and methods that are computer implemented for professional service organizations and allow the organizations to offer prepaid, low-cost, memberships, particularly in the case of tax audit defense plans.

In order to competently handle large volumes of cases or claims and deliver the appropriate mix of professional services promptly and at high quality on every occasion, it is important for organizations to implement systems that can accommodate high volume and operationally flexible. In general, they must also provide cost efficiency, even when high case volume it arrives. After measuring an adequate amount of data, it can be important and useful to determine whether there are statistical patterns in individual tax filings within tax season and throughout the year and to implement effective measures based on these patterns.

Technological systems and methods described herein provide a wide variety of technological solutions for providing ongoing professional service improvements for these types of organizations. These can include measurements of time and efficiency, integrated triggers that alert employees when the application of licensed professional judgements may be required, scheduling of events, complex orders of operation, and many others. In layered organizations with proportionally large numbers of discrete lower level tasks, many of these tasks may be performed according to computer implemented and measured work, quality, and timing standards and metrics that help to insure the organization's administration of uniformity. Data and task progress and completion can be monitored in real time and compared to standardized metrics, thus optimizing workflow and allowing for the organization to handle a larger volume of cases. In some cases, this can be performed according to a number of different staff configurations.

The ability to deliver uniformly high quality licensed professional services to high volumes of cases that are resilient, despite fluctuations in case volume, allows for organizations implementing these features to drive down costs for producing these types of services without sacrificing professional care. In some embodiments, this is achieved by atomizing individual tasks and effectively evaluating internal processes. This provides an efficient production engine for services that is smooth and flexible and retains profitability, while at steady, increasing, or decreasing volume amounts. Results can include cost-efficiency savings with increased profit by exploiting computer implemented, measured, and executed processes with efficient workflow distribution, measurement of timing for tasks, alerts for managers based on standardized metrics, auto-generated communications within the system, reporting, and modifications thereof.

In many embodiments, a baseline or average level of uniform standards for work production can be initially established by measuring, at a granular level, the time and level of performance for each task performed by each person that works on each case. Once the system has measured and created these baseline standards, optimization of tasks, procedures, and their associated organization can be determined and implemented for increased efficiency, better customer relations and service, and profit improvements.

In some embodiments, these technological solutions ensure that each client of an organization will be assigned a licensed case supervisor that is the responsible holder of the individual client's “power of attorney.” This case supervisor can be personally accountable for all aspects of professional services performed and delivered to the client, and ultimately the overall case outcome. This can be performed through an optimized standardization of tasks that are set, measured, and analyzed in a consistent order, allowing for completion of each task before pushing the case forward as a work in progress to the next task. Further, this can allow for optimization of standardized skill sets and approaches to tasks, measuring performance against predefined standards, constant supervision, modifications, and improvements in the overall system.

In some embodiments, the present disclosure includes a server-based system for optimizing and managing high volume processes having discretized and atomized tasks and components over a network, comprising: a management optimization server, communicatively coupled to the network, comprising: at least one database, stored in non-transitory computer readable memory; at least one timer; and at least one server processor, a user device, communicatively coupled to the network, comprising: non-transitory computer readable memory; at least one user device processor; a user interface display; a user interface input; wherein the at least one user device processor is configured to log a selected user into a server based portal via the network, receive, from the management optimization server via the network, at least one task instruction for a task, cause the user device to display one or more steps related to the task, track user input entered by the selected user via the user interface input, and transmit at least one completed task result to the management optimization server via the network; and wherein the at least one server processor is configured to store a series of tasks required for completion of a plurality of cases in the at least one database, determine a current task for completion for a selected case of the plurality of cases based on a case history profile associated with the selected case and stored in the at least one database, transmit at least one task instruction for the selected case to the user device based on the selected user's credentials, monitor a time for completion of the current task using the at least one timer, and upon receiving the completed task result, update the case history profile to reflect the status of the current task as completed.

In some embodiments, the present disclosure includes a computer-based method for optimizing and managing high volume processes having discretized and atomized tasks and components over a network, comprising: at a user device: logging a selected user into a server based portal via a network, receiving, from a management optimization server via the network, at least one task instruction for a task, causing the user device to display one or more steps related to the task, tracking user input entered by the selected user, and transmitting at least one completed task result to the management optimization server via the network; and at a management optimization server: storing a series of tasks required for completion of a plurality of cases in at least one database, determining a current task for completion for a selected case of the plurality of cases based on a case history profile associated with the selected case and stored in the at least one database, transmitting at least one task instruction for the selected case to the user device based on the selected user's credentials, monitoring a time for completion of the current task using at least one timer, and upon receiving the completed task result, updating the case history profile to reflect the status of the current task as completed.

Various alterations and modifications are contemplated without departing from the overall spirit and scope of this disclosure. The configuration of these systems, methods, and devices is described in detail by way of various embodiments which are only examples.

Other systems, devices, methods, features and advantages of the subject matter described herein will be or will become apparent to one with skill in the art upon examination of the following figures and detailed description. It is intended that all such additional systems, devices, methods, features and advantages be included within this description, be within the scope of the subject matter described herein, and be protected by the accompanying claims. In no way should the features of the example embodiments be construed as limiting the appended claims, absent express recitation of those features in the claims.

### BRIEF DESCRIPTION OF THE DRAWING(S)

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

Illustrated in the accompanying drawing(s) is at least one of the best mode embodiments of the present invention. In such drawing(s):

FIG. 1A is an example embodiment of a basic network setup diagram, according to an embodiment of the disclosure.

FIG. 1B is an example embodiment of a network connected server system diagram, according to an embodiment of the disclosure.

FIG. 1C is an example embodiment of a user mobile device diagram, according to an embodiment of the disclosure.

FIG. 2 shows an example embodiment flow chart diagram of a case manager process, according to an embodiment of the disclosure.

FIG. 3 shows an example embodiment flow chart diagram of an administrator process, according to an embodiment of the disclosure.

FIG. 4 shows an example embodiment flow chart diagram of another case manager process, according to an embodiment of the disclosure.

FIG. 5 shows an example embodiment flow chart diagram of a case specialist process, according to an embodiment of the disclosure.

FIG. 6 shows an example embodiment flow chart diagram of another case specialist process, according to an embodiment of the disclosure.

FIG. 7 shows an example embodiment flow chart diagram of another case manager process, according to an embodiment of the disclosure.

FIG. 8 shows an example embodiment flow chart diagram of another case manager process, according to an embodiment of the disclosure.

FIG. 9 shows an example embodiment flow chart diagram of another administrator process, according to an embodiment of the disclosure.

FIG. 10 shows an example embodiment of tax filing volume surges in Fiscal Year 2012.

FIG. 11 shows an example embodiment of estimated tax audit service claim arrivals over a four-year period.

FIG. 12 shows an example embodiment of a traditional organization or professional service firm structure.

FIG. 13 shows an example embodiment of a traditional low volatility, high volume (LVHV) organization or professional service firm structure.

FIG. 14 shows an example embodiment of a mirroring organization or professional service firm structure.

FIGS. 15A-15H show an example embodiment of a high-level diagram with various tasks and procedures for an individual case that are discretized and atomized, according to an embodiment of the disclosure.

FIG. 16 shows an example embodiment flowchart of a process of standardizing organization for a professional service firm.

FIG. 17 shows an example embodiment of a high-level diagram flowchart whereby the system can determine an issue and any initial supporting evidence before gathering, assembling, and analyzing related and applicable data, and then formulating the data into a cogent defense, according to an embodiment of the disclosure.

FIG. 18 shows an example embodiment of a high-level diagram providing scalability of processes with minimal requirements for new staff training and hiring, according to an embodiment of the disclosure.

FIG. 19 shows an example embodiment of a user interface diagram. As shown in the example embodiment, a case report can be generated by the system that includes various individual tasks.

### DETAILED DESCRIPTION

Before the present subject matter is described in detail, it is to be understood that this disclosure is not limited to the particular embodiments described, as such may vary. It is also to be understood that the terminology used herein is for the purpose of describing particular embodiments only, and is not intended to be limiting, since the scope of the present disclosure will be limited only by the appended claims.

In general, the systems, devices, and methods described herein provide technological solutions that can allow an organization to tailor and optimize their service production for customers. In general, tasks and processes herein contemplated can be highly atomized such that they are performed competently by appropriate personnel who are appropriate for the task. This can help avoid overbilling by those with paygrades that are above the level of the task that requires performance, while also avoiding underdelivering due to incompetence by assigning tasks that are unable to be effectively performed by unqualified personnel.

In some embodiments, generally, the present disclosure may include systems, methods, and devices for optimizing and managing high volume processes by atomizing the work into discrete elements, tasks and components, and batching similar elements, and then tracking, pushing, gating, automating and monitoring in real time workflow task element groupings to which appropriate knowledge-worker skill sets are matched and assigned just in time, and then reassembled into a finished product as to which quality control standards may be enforced uniformly throughout, via a network, where case files are stored on one or more network connected organization management optimization servers in real-time, as they are completed on one or more network connected user devices.

One exemplary market that may benefit greatly from such a solution would be the millions of US taxpayers who every year must respond to formal written inquiries and notices from income tax authorities, with the risk of worsening their problem because they are unfamiliar with the regulation set and the modes of practice by which the Examination Division of the Internal Revenue Service (IRS) operates.

The exemplary market for low cost, prepaid, tax audit defense plans was identified to serve average US taxpayers who were largely unserved with licensed professional representation in the face of the substantially growing number, ranging into the millions by 2010, automated tax notices issued to U.S. income tax payers by the IRS. The automated formal inquiries grew as the IRS realized the scalability of applying computer algorithms to millions of e-filed tax returns and the potential of collecting more tax, not large individual amounts with difficulty from tax evaders, but rather, smaller amounts from millions of complying taxpayers. The inquiries, based on a growing number, scope and reliance on hypotheses embedded in discrete computer algorithms, mostly conclude with a demand for more tax due. Many times, the IRS computations are correct in fact and law, but many times they are not, which suggests the advantage of professional representation. The primary obstacle to acquiring licensed professional representation in the income tax audit resolution market has been the prohibitive cost relative to the frequently relatively small, by professional practitioner standards, amounts in controversy, and frequently not knowing where, and to whom, to turn. The present disclosure may provide solutions, among others, to configure, market, sell and fulfill the professional services obligations of a low cost, prepaid tax audit defense plan for the average taxpayers.

In some embodiments, the present disclosure may include approaches to serving cascades of claims for professional services at uniformly enforced standards of practice and customer service quality, monitored in real time instead of after-the-fact by customer survey, and by methods permissive of continuous process improvement and cost reduction. The present disclosure may include a novel technological approach that may be tailored for each customer to provide a full-service, licensed professional service experience and care, regardless of the complexity or duration of each individual case, and regardless of the total number of cases handled by an organization. With the present disclosure, the volume and pacing of service claims may have little or no impact on the experience of the individual claimant. Because the claims resolution process is a centralized, governed workflow approach, continuous process improvement reduces cost of service at the same time it reduces sources of unacceptable variation or impairment to the highest standards of practice and customer service.

While taxpayers may benefit from the innovative approach to high-volume, high quality systems and methods described herein, licensed and regulated professional service providers, insurance claims adjusters and processors, and disaster and benefits claims processors, in a variety of markets and practice areas who deploy the systems and methods of the present disclosure within their organizations may also benefit, for example, by being able to configure, package, sell and service prepaid services plans covering a variety of markets and practice areas, at uniformly monitored and enforced professional standards and customer service quality, at significantly reduced costs of service.

In some embodiments, the present disclosure may maximize speed, quality, and efficiency of handling cases in a licensed professional service-environment including complicated, multilayered issues, with heightened importance to assuring monitoring and enforcement of uniform customer service standards. At the same time, the present disclosure may minimize costs for customers. In exemplary income tax inquiry resolution scenarios, a multitude of unique situations and fact patterns may occur across tax audit defense prepaid plan purchasers. Further complications arise when individual members have a number of issues embedded in the IRS challenge, all of which must be dealt with while maintaining a high level of productivity and uniform quality control. The present disclosure may deliver these results in analogous licensed professional service fields providing sophisticated services, and may assure uniform quality. In some embodiments, by substantially decreasing cost of service, the present disclosure may open up the feasibility of offering, and proliferating, pre-paid service products to new markets.

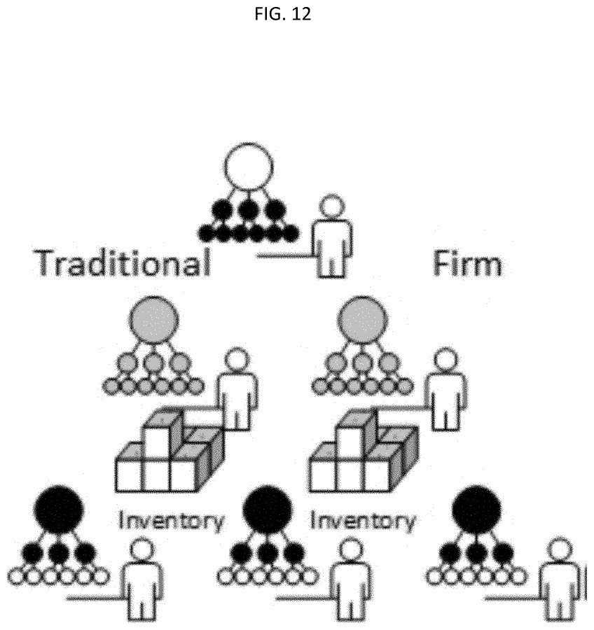

Under traditional organizational approaches (see also FIG. 12), providing licensed, accredited, “do-it-for-you” or “stand-in-your-shoes” representation under power of attorney for massive volumes of clients (e.g., measured in tens or hundreds of thousands) in professional service industries, such as in the income tax audit defense and tax identity recovery markets, law or accounting firms, is considered a challenge without precedent. Organizations handling these matters can include a variety of personnel, including accountants, tax lawyers, IRS enrolled agents, paraprofessionals, support personnel, and other staff members, who each may have different skills, levels of skills, functions, and priorities. Professional service firm management is complex in the best of times, and under typical forms of organization, are limited in the volume of throughput they can handle by conventional staffing and process capacity thresholds. If an unanticipated wave of work appears, the risk of processes seizing up is real. The present disclosure provides tools and methods for organizing, conducting, accelerating, monitoring, and reviewing work in professional service firms that comprise a variety of professionals with different skills.

Traditional professional service firms that engage in work requiring both licensure and accreditation have historically been organized in a simple hierarchy. One example is the traditional law firm model, where the lawyers have court accreditations and bar membership. In these organizations, there are one or more licensed principal partners who serve dual functions. First, they serve as “billing” partners responsible for the firm's account relationship with clients. Second, they serve as the primary substantive “strategist” for individual client cases. Day-to-day tactical execution on the case may be handled by one or more associate attorneys who act as case managers. Each case can have a case managing attorney who acts as a foreman, thus steering the day-to-day tactical execution of all of the operations required to prosecute the case. The case managing attorneys manage or perform most of the case operations for each case. The fact that one individual ends up performing proportionally so many functions on a case, even those not requiring licensure and accreditation, can be a limiting bottleneck for the throughput of the law firm as a whole.

From an operational perspective, the total workable case inventory for a firm can depend on case inventory capacity of the case managing attorneys. Paralegals, secretaries, word processors, receptionists, and other staff can handle incoming calls from current and prospective clients and other parties in supporting roles. These roles constitute easier-to-substitute and less expensive labor input. Thus, the firm's economic viability can depend on the case managing attorneys, since they determine a maximum case load capacity and the throughput speed of each case. Some cases can be highly complex and nuanced, so associate attorneys will often consult with partners to determine case strategy and to vet tactical approaches. However, associate attorneys are also valued based on how quickly they can apply their own judgement autonomously and without supervision.

This traditional law firm model works well for organizations that have low case volumes, where individual cases have a high degree of complexity. However, it tends to be throughput constrained based on the number of attorneys that the firm employs, e.g., at the case management level. This model can be relatively brittle and lack flexibility because each case the firm takes on requires a case managing attorney to execute end-to-end operations. Thus, a large influx of cases at any given staffing level can cause the system to seize up and thereby decrease client service for all clients. When this occurs, the firm often needs to recruit and hire additional attorneys, and then educate them on the issues for the cases that they are assigned. Therefore, a traditionally organized firm facing a rapid increase in the volume of cases is often unable to fluidly and efficiently scale their business to accommodate the increased workload—to the disadvantage of the incoming clients.

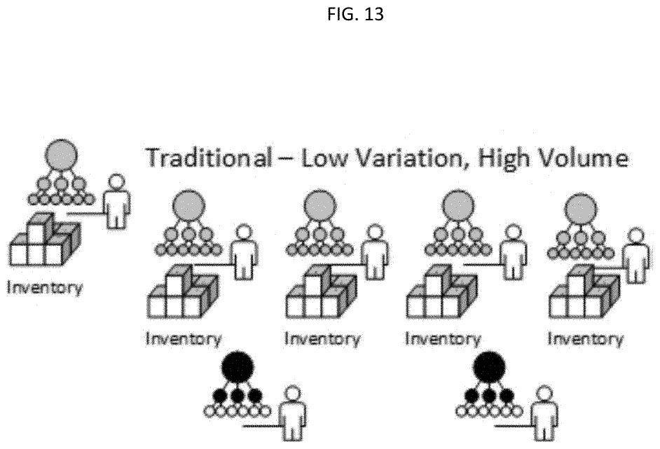

Adapting a traditional professional services model for lower complexity cases with higher volume can be difficult for traditional firms, although one approach that met some success is the boutique or specialized firm type model. In practice, this second type of organizational structure is a low volatility, high volume structure (“LVHV”, see also FIG. 13), which means that a law firm develops a specialization and restricts its practice to cases in a very narrow range. If cases have minimal variation, a frequently recurring counterparty, or have a narrow set of applicable laws, rules, and procedures, then the firm can handle a higher volume of cases. These firms require a reduced need for a supervising attorney to be frequently involved in determining, monitoring, and fine-tuning strategies for every case. Some of these firms would assign an individually accountable supervisor to primary client relationship management as a quality check and balance. However, with this model it was possible to forgo the expense of maintaining a sizable supervisory staff tier by consolidating cases with similar issues and fact patterns with an assigned case manager who is responsible for managing the relationship with the client. Due to the repetitive nature of administrative case operations, these firms require reduced support staff compared to other firms and are able to support higher volumes of cases. However, a primary limiting factor requires that each case has an assigned case manager to manage and execute tactical case operations from inception to resolution. As such, the firm's case throughput is constrained to the individual and collective productivity of the licensed professional case managers that combine to work on the firm's case inventory.

On the other hand, tax audit defense and tax identity recovery services are substantially less complicated than the cases handled by the streamlined and specialized law firms. This is a result of needing to primarily deal with only one counterparty, repetitively, in a constrained jurisdictional setting, namely the Examination Division of the IRS and the State level equivalents. As such, cases of these firms are constrained to a relatively simple and repetitive procedural rule set. Case manager organization can thus be further streamlined for more savings. These firms therefore require a reduced overall number of employees proportional to their total case inventories. However, they are still constrained by the number of competent case managers for their total inventory capacity and throughput. In addition, these organizations are still constrained by their ability to provide uniform, high quality client service for all clients, and to provide cost-efficiency in the face of case load volatility.

Thus, traditional LVHV firms are still prone to having productivity bottlenecks and stoppages with unanticipated volume increases and are unable to efficiently scale fluidly or efficiently with respect to volatile throughput demand and cost per case.

As described above, traditional models and traditional LVHV models run the risk of seizing up when confronted with high fluctuation in the volume of cases requiring management. When the total volume of cases exceeds the immediately available throughput capacity of the aggregate case managers, the system is at full capacity. Frequently, one of the first adverse effects is a drop in the quality of work as employees simply do more of the same things, faster and without additional resources and tools.

The organizational model currently used by some mass-consumer tax preparation companies selling tax audit defense plans, with millions of plans deployed among US taxpayers, operates by recruiting, expanding and contracting a geographically dispersed network of individual tax practitioners operating on an independent contractor model (here referred to as the Brute Force Approach). Where case managers are independent contractors who bear the cost of their own licensure, work environment, and liability insurance, this can provide lower cost of service to the tax preparation companies that sell the plans and own the primary customer relationship, savings sometimes passed on to customers, in part, sometimes not. However, there are disadvantages to all parties to the transaction, the customer, the marketer and the service provider, of the Brute Force Approach.

First, problems with recruitment and maintenance of a substantially sized network of independent case workers can make management unwieldy and difficult, requiring constant maintenance and expenditure of organizational effort. Second, certifying professional competency is complicated, since the independent contractors are inherently required to exercise their idea of professional judgment idiosyncratically and autonomously. This can lead to an overly complex, if not impossible, professional quality control system. When new employees require on-the-job training, it can degrade the throughput of cases for training managers when maximum efficiency may be required due to an influx of case volume.

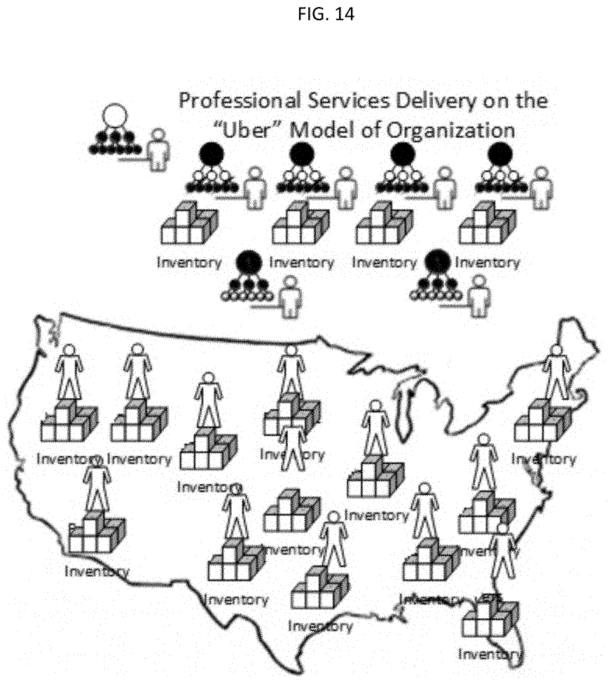

As such, quality control may become contingent on customer feedback surveys instead of contemporaneous supervision by educated, experienced supervisors. For example, in some instances, clients may be slow-to-respond, cases may be overly complex and ill-suited to a particular contractor's skillset, or the contractor may introduce other inefficiencies into the overall process. Customer feedback is also after the fact. As such, many or all quality control challenges in mirroring systems (using independent contractors, see also FIG. 14) are the result of symptoms of the independent contractor's relationship with the customer or client and are therefore, outside the realm of direct-observation professional supervisory control processes.

Another disadvantage of these mirroring systems is that they require guesswork or estimation on the part of the selling organization to know exactly what the independent contractors should be paid. Rates for work are determined on the amounts needed to produce in sufficient numbers for cascading caseloads practitioners willing to do the work, and have nothing to do with efficacy and quality delivered to the customer. With independent contractors, by definition, there is no uniform work standards. Internal organizational process improvement is virtually impossible and therefore no improvement to cost efficiency, without sacrificing quality of service delivery can be gained by the organization.

Thus, although the mirroring models can scale, they employ a brute force, people-intensive strategy that includes large quantities of independent case managers with decentralized, tenuous spans of control. As such, they are a challenge to manage effectively, particularly when trying to provide uniform, high quality, licensed professional service standards that are efficient and cost effective for customers while also being profitable for the organization.

In some instances, the mirroring model can sometimes meet the challenge of case volume surges by rapidly engaging vast quantities of independent contractors as case managers. However, as described above, existing challenges for the mirroring models include the continual identification, inculcation, and maintenance of independent contractor network. As such, licensed case managers are necessarily recruited in large numbers and organizations must determine, and attempt to test and enforce, a minimum standard of competency without firm guarantees of their individual depth or breadth of expertise. The lack of a reliable and timely method to detect and remedy substandard work can lead to negative client service experiences and reduction in overall profitability, detected only after the fact.

As described above, the traditional, traditional LVHV, and mirroring models may each incur quality and professional standard of care challenges. These models each incur difficulties when attempting to provide uniformly high professional standards of practice across each case manager for every of thousands of cases. The system of the present disclosure solves these problems by providing an effective real-time system that monitors performance of each employee for each task that is required in every step of every phase of a customer's case,

Further, the traditional and traditional LVHV methods require supervisors to identify any gross deficiencies with case managers, or gross decreases in firm-wide case completion productivity, before the organization can find and implement a remedy process. If case managers are inefficient in managing timing for a case, in traditional and traditional LVHV firms the short-term dollar cost of that inefficiency is borne by the firm, in mirroring systems, that cost is borne by the independent contractor. In a mirroring system the long-term cost to customer service will not become apparent until later, when the organization receives negative customer “after action” reports over some pre-defined triggering threshold on a particular independent contractor. This can require accumulating enough reports for each independent contractor to rule out any statistical anomalies—and in the meantime, the damage to customer service continues.

None of the models described above provide a process that is able to continuously improve, in order to capture economies of scale consistently and permanently, while decreasing costs and maintaining or increasing profit. Particularly, these models lack technological mechanisms to identify and refine procedures for all case managers, at every step of every case phase, for every case.

Another challenge is how best to internally measure and understand whether and when a volume of IRS's Single-Issue Audits (“SIAs”) may occur. In many cases, a source of potential claims under a tax audit defense plan originates from SIAs. A SIA notice may arrive in a taxpayers' mailbox in the form of a form letter that is triggered after a computerized scan for anomalies of millions of e-filed tax returns. As the IRS quickly discovered a high level of return on investment from this program, the agency developed more algorithms to define anomalies, determine balances due, and demand payment. The methodology by which the algorithms are constructed has evolved to ever more theoretical and presumptive constructs of norms and deviations that frequently challenge taxpayers on the basis of interpretative suppositions, not proven facts or common applications of tax law. As a result of these programs being automated and their positive return on investment, the IRS now issues SIAs to approximately 10% of all individual tax payers, on the order of 10 to 15 million annually. The scale of challenges for tax audit defense services offering membership plans has increased materially half decade.

Disclosed now are systems, methods, and processes that provide technological solutions for improving professional services delivery models in terms of long term economic viability, scalability, and profitability, while minimizing or eliminating fundamental weaknesses described above. The present disclosure can deliver uniform service output of a consistent high quality that is also timely and profitable, despite fluctuations in case volume. The various embodiments below provide systems and methods that are computer implemented for professional service organizations and allow the organizations to offer prepaid, low-cost, memberships, for example, as in the case of tax audit defense plans.

The present disclosure may include mobile applications, mobile devices such as smart phones/tablets, application programming interfaces (APIs), databases, social media platforms including social media profiles or other sharing capabilities, load balancers, web applications, page views, networking devices such as routers, terminals, gateways, network bridges, switches, hubs, repeaters, protocol converters, bridge routers, proxy servers, firewalls, network address translators, multiplexers, network interface controllers, wireless interface controllers, modems, line drivers, wireless access points, cables, servers and others equipment and devices as appropriate to implement the methods and systems described herein.

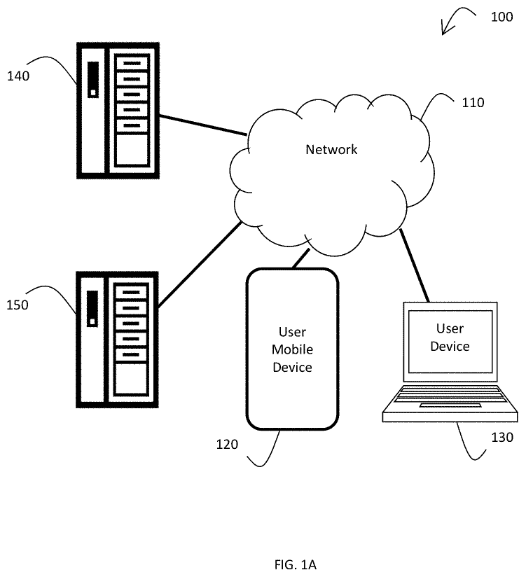

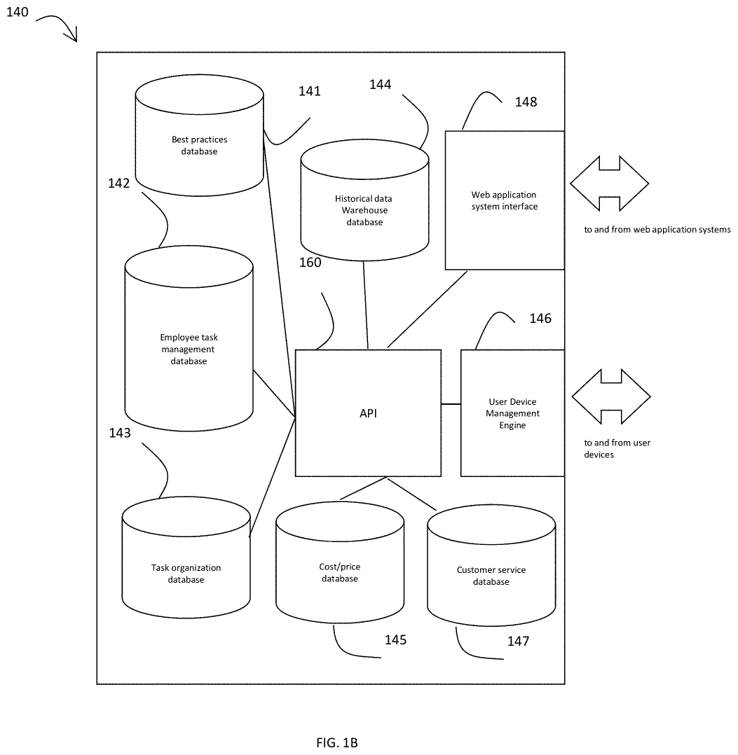

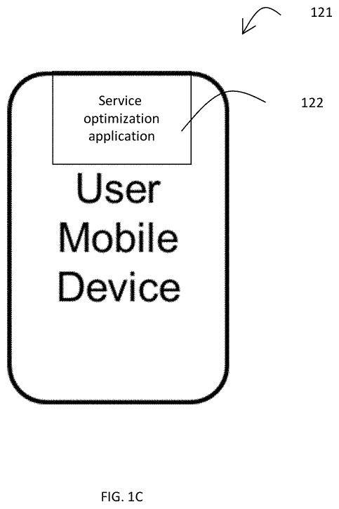

Turning now to FIG. 1A, an example high-level diagram of a basic network setup 100, according to some embodiments of the present disclosure, is illustrated. As shown in the example embodiment, network setup diagram 100 may include multiple servers 140, 150 which may include applications distributed on one or more physical servers, each having one or more processors, memory banks, operating systems, input/output interfaces, power supplies, network interfaces, and other components and modules implemented in hardware, software or combinations thereof as are known in the art. These servers may be communicatively coupled with a wired, wireless or combination network 110, such as a public network (e.g., the Internet, cellular-based wireless network or other public network), a private network or combinations thereof as are understood in the art. Servers 140, 150 may be operable to interface with existing or later developed websites, webpages, web applications, social media platforms, advertising platforms, and others. As shown, a plurality of end user devices 120, 130 may also be coupled to the network and may include, for example: user mobile devices such as smart phones, tablets, phablets, handheld devices, media players, laptops; wearable devices such as smartwatches, smart bracelets, smart glasses or others; and other user devices such as desktop computer devices, fixed location computing devices,; or other appropriate devices with computing capability and network interfaces and operable to communicatively couple with network 110.

Those of skill in the art will understand that the method steps disclosed herein can comprise instructions stored in non-transitory computer-readable medium or memory of the servers and user devices, and that the instructions, when executed by the one or more processors of the servers and user devices, can cause the one or more processors to perform the steps disclosed herein.

FIG. 1B is an example high-level diagram of a network connected server system 140, according to some embodiments of the present disclosure. As shown in the example embodiment, server system 140 is a computer implemented professional service optimization server system, which may include at least one user device interface 146 implemented with technology known in the art for facilitating communication between user devices and the server, and communicatively coupled with a server-based application program interface (API) 160. API 160 of the server system may also be communicatively coupled to at least one web application server system interface 148 for communication with web applications, websites, webpages, websites, social media platforms, and others that are internally sourced by an organization, hosted by a third party, or combinations thereof in various embodiments. As such, it can access information via a network when needed.

API 160 may also be communicatively coupled with a best practices database 141, an employee task management database 142, a task organization database 143, a historical data warehouse database 144, a cost/price database 145, a customer service records database 147, and any combinations thereof or other databases and other interfaces. API 160 can instruct databases 141, 142, 143, 144, 145, 147 to store (and retrieve from the database) information such as variables, elements, best practices, account information, or others as appropriate. Databases 141, 142, 143, 144, 145, 147 can be implemented with technology known in the art, such as relational databases, object oriented databases, combinations thereof or others. Databases 141, 142, 143, 144, 145, 147 can be distributed databases, and individual modules or types of data in the database can be separated virtually or physically in various embodiments. Further, one or more of these various databases can be combined, eliminated, or supplemented with additional databases in various embodiments. These databases can include best practices information, measured employee task management information, task organization hierarchies and processes, cost and pricing information, customer service records, historical data, and various other types of information and data, as appropriate.

FIG. 1C is an example embodiment of a user mobile device diagram 121. As shown in the example embodiment, a user mobile device 121 may include a network connected service optimization application 122 that is installed in, pushed to, or downloaded to the user mobile device. In many embodiments, user devices may be touch screen devices such as smart phones, phablets or tablets which have at least one processor, network interface, camera, power source, memory, speaker, microphone, input/output interfaces, operating systems and other typical components and functionality. It should be understood that application 122 may be omitted, supplemented, or replaced with another functional application in various embodiments, such as a browser, dashboard application, or others as appropriate. Further, user mobile device diagram 121 can be omitted, supplemented, or replaced by another user device, such as a laptop, desktop, or other type of computing device in various embodiments.

As described previously herein, in various embodiments, the time required to complete each individual task for every phase of a particular case may be measured using an automatic or semi-automatic timer that is implemented on the server or client computer in various embodiments. For example, when an employee of an organization receives a particular task and opens it, for instance, in a dashboard, email, docket, or application, a timer may be started by the user selecting an appropriate icon or button on a user interface screen. This timer may have an automatic timeout that may be set at a predetermined time which can measure inactivity by a user. In some instances, this may trigger a reminder or popup for a user to see if the user is still working on the task but is reading information on the screen or performing operations on a non-system connected device, such as a calculator not on the computer. Once a task is completed, the user may select a task completed or other appropriate icon on the user interface, at which the timer will stop and the information may be stored by the server in a database, with similar data. This information can also be saved for the individual user to measure, track, and produce reports, e.g., for individual users or other purposes.

Once a sufficient amount of data has been collected for a particular type of task, for instance, by meeting or exceeding a particular iteration or data point threshold, the system can perform one or more operations and compile a report that details important information and metrics related to the task. This may include, mean, median, maximum, minimum, standard deviation of all measurements, ranges, and various others as appropriate. This information may be collected for particular time periods, such as particular times of day, days of the week, times of the month, and others, to further provide additional useful information. This data can provide a robust data environment in which users, system administrators, and others can view data in various forms, such as charts, graphs, lists, and others. Also, once compiled, a target amount of time may be set for individual tasks, processes including multiple tasks, and other functions, as appropriate. These targets can be set automatically in some embodiments, with manual or automatic adjustments in various embodiments. Targets may also be displayed on a user interface for an employee in various embodiments, such that the employee may be informed of whether they are falling behind personal or standardized timing goals.

Some embodiments also include incentive systems for employees who complete one or more tasks more efficiently or who show improvements over a preset or variable amount of time, as compared to a threshold or range of values.

In various embodiments, the system provides optimized service based on discretized numbers of levels. For example, work can be organized into tasks that are able to be performed by individual employees who are within a certain level, based on their skills, knowledge, experience, certification, and other metrics. These metrics may be preset into an employee profile that is maintained in non-transitory memory such as a database that is coupled with or hosted on the server. As such, tasks may be pushed or assigned to particular individuals based on their individual metrics. This ensures that work is not assigned to incorrect individuals, lacking or overqualified in skills and knowledge. In some embodiments, different users can be assigned different task requirements based on their experience and time with the organization.

Also in various embodiments, each individual employee may be assigned particular tasks in a docket, email or other task inbox, listing, on a dashboard or in another appropriate fashion. These tasks may be completed in a particular order, based on the previous tasks that have been performed for the particular case to which they are assigned and according to a best practices process or instruction. Thus, tasks may be prevented from being performed out of order for each individual case and the case is always maintained in a track that ensures it will be performed in optimal fashion. This removes any manual errors that may otherwise occur. Further, it ensures that each case is handled with great care individually.

In some exemplary implementations and practices, once a task has been completed, a completed or other appropriate flag may be set by the server system for that particular task. Once completed, the documents or other information related to the task may be stored electronically in a case file that is organized based on the nature of the case. This case file can be opened and reviewed electronically by selecting it from an appropriate location. Each of the documents or tasks can then be individually opened as appropriate and reviewed, minimizing or eliminating the time required and need for individual employees to familiarize themselves with unique case files, since they are assured that the tasks prior to the task they have been assigned are completed in adequate and appropriate fashion, system-enforced by gating criteria. At various times or at any time, a case manager that is managing a particular case can open the case file and spot check tasks or documents, or review information such as timing of tasks to check for accuracy and efficiency for each case file overall.

In some embodiments, best practices may be measured and weighed against each other or various thresholds in order to determine whether an individual process, group or segment of processes, or the overall system in general is functioning efficiently.

In some embodiments, numerous triggers may exist in the system to alert employees, case managers, administrators of various system qualities and quantities, and others. For example, if a particular task is coming up on a predetermined deadline and has not yet been completed, the system may notify the employee it is assigned to, the case manager, or both of the impending deadline via an alert. Alerts can be auditory through speakers, kinesthetic via vibration of a device using a motor, visual, through icons or popups, or others, as appropriate. In some embodiments, the system may automatically reassign tasks or sets or groups of tasks to other users if one or more preset triggers have occurred. Further, alerts can be implemented based on an influx or dearth of incoming or outgoing cases by using preprogrammed surge indicators. Other triggers and alerts can be implemented that can indicate overall system efficient, database memory levels, processing power, and others for service personnel.

In some embodiments, customer service emails or calls from clients or other customers may be automatically transcribed and stored in databases. These can be automatically added to an electronic case file, such that they can be easily reviewed by case managers. In some embodiments, the system may be able to automatically provide automated service notification about case statuses, such as in the form of calls, emails, text messages, multimedia messages, or others to employees or customers about particular issues pertaining to cases, based on system triggers.

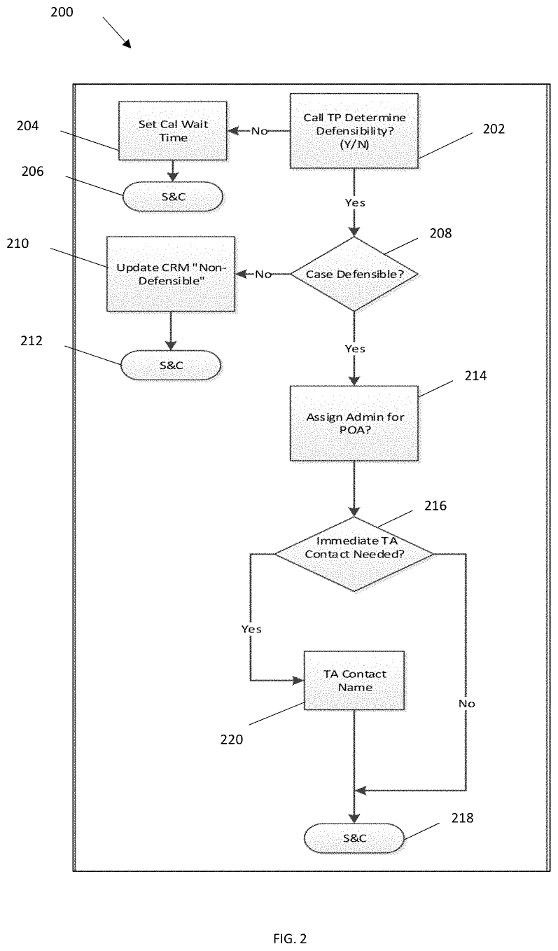

FIGS. 2-9 show exemplary high-level flow charts of 4 major professional service system and method types or processing types, including: 1) management and maintenance; 2) face to face; 3) correspondence; 4) Tax Identity Recovery (TIR); and 5) others. These flow charts are graphical representations to specific processes that each includes various tasks that must be completed for the particular process shown. In some embodiments, these can be linked or otherwise coupled with a content rights management (CRM) system, such that a particular flow process type is selected by a Customer Service Representative (CSR) administrator or automated process for a specific functional request. These can be based on a case state or other metric. Once selected, the system may take over the management functions within each process and sub-process, including the assignment of tasks, triggering of alerts, and other automated processes and functions.

The functional description of an individual process that includes a variety of tasks can be thought of as a component in some embodiments. In one aspect of some embodiments, the process may be modelled after a bill of materials in a typical manufacturing assembly line process. Although four exemplary different processing types are shown, in various embodiments, additional types can be included, or types can be removed, and each may individually include a number of distinct “processes components” (e.g. 5, 9, or others) and each component may have a number of sub-process components, (e.g. 6, 7, 13, 27, or others). Each sub-component may yet have ‘dependent’ sub-processes, of various quantities. As in a manufacturing system, the systems described herein can be designed to halt, pause, or otherwise stop moving forward if there is a dependent sub-process that has not been completed. These can be based on one or more triggers, causing other functions, such as alerts. These may restart automatically, manually, or combinations thereof. These may also be terminated manually, automatically, or combinations thereof, when appropriate. In various embodiments, each process may be required to be positively completed before the system proceeds to a subsequent step or sub-step and one or more users are allowed to perform the next step that is scheduled.

FIG. 2 shows an example embodiment flow chart diagram 200 of a case manager process.

As shown in the example embodiment, a first step 202 can be a call Tax Payer (TP) to determine defensibility. If no call is made or needed, set calendar wait time step 204 can occur, after which the system can Save and Close (S&C) in step 206. If a call is made or needed, then the system can determine whether the case is defensible in step 208. If not defensible, in step 210 the system can update CRM to “non-defensible” status, after which the system can S&C in step 212. If the case is determined defensible in step 208, the system can determine whether to assign an administrator for Power of Attorney (POA) in step 214. Afterwards, the system can determine whether immediate Taxing Authority (TA) contact is needed in step 216. If none is needed, the system can S&C in step 218. Otherwise, in step 220, TA contact name can be determined in step 220 before the system can S&C in step 218.

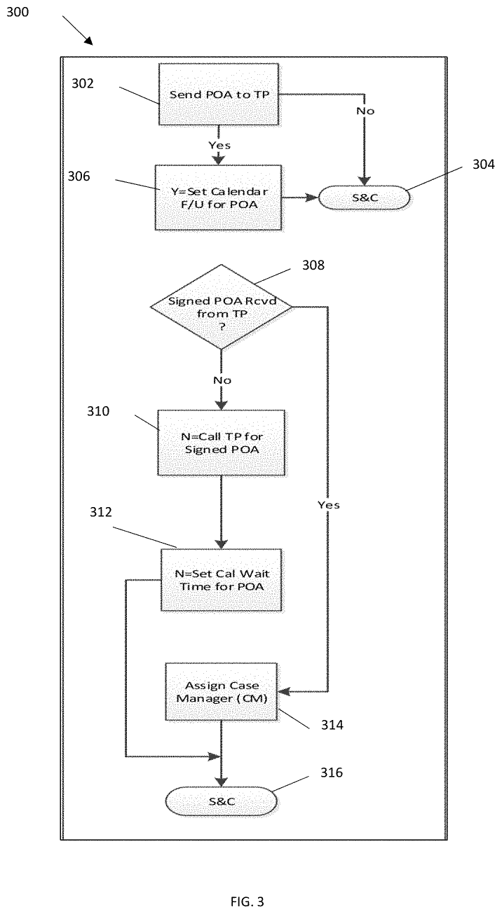

FIG. 3 shows an example embodiment flow chart diagram 300 of an administrator process.

As shown in the example embodiment, a first step 302 can be to determine whether there is a need to send a POA to Tax Payer (TP). If there is no need, the system can S&C in step 304. Otherwise, if there is a need, the system can set a calendar Follow-Up (F/U) for POA in step 306 before S&C in step 304.

Also shown in the example embodiment of FIG. 3 is a step 308 to determine whether a signed POA has been received from the Tax Payer (TP). If not, the system can call the TP for a signed POA in step 310 and set a calendar wait time for the POA in step 312 before S&C in step 316. Otherwise, if the signed POA has been received from the TP in step 308, the case can be assigned to a case manager (CM) in step 314 before the system can S&C in step 316.

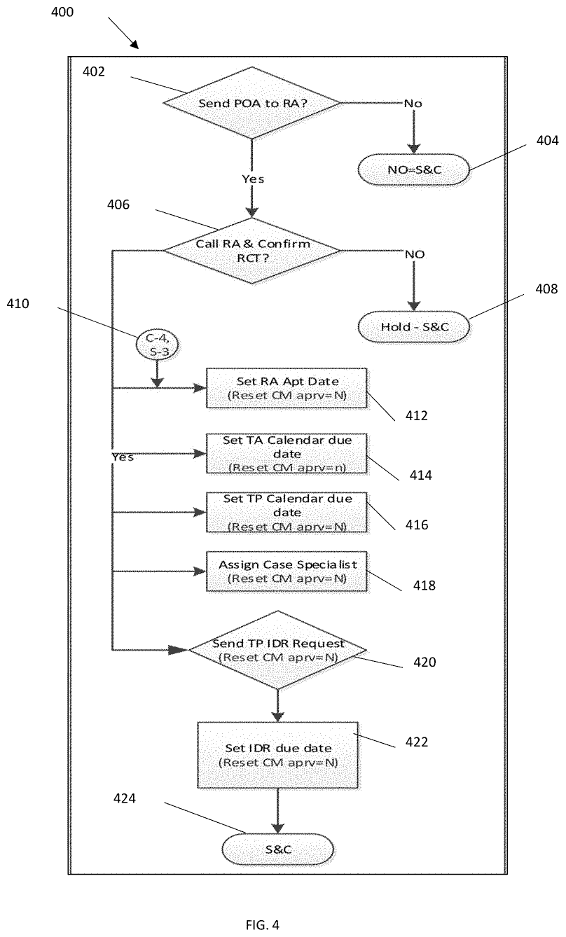

FIG. 4 shows an example embodiment flow chart diagram 400 of another case manager process.

As shown in the example embodiment, a first step 402 can be to determine whether to send a POA to a Revenue Agent (RA). If not, the system can S&C in step 404, otherwise it can determine whether to call the RA and confirm receipt (RCT) in step 406. If a determination of no occurs in step 406, the system can S&C in step 408. Otherwise, if yes, the system can perform a number of further steps. These may include applying Component-4, Step-3 (C-4, S-3) in step 410 before setting a RA appointment date in step 412. Further, the system can set TA calendar due dates in step 414, set TP calendar due dates in step 416, assign case specialists in step 418, and determine whether to send TP IDR requests in step 420. If TP Information Data Request (IDR) requests are sent in step 420, the system can set IDR due dates in step 422 and then S&C in step 424. Each of steps 412, 414, 416, 418, 420, 422 may also cause resetting CM approval to no.

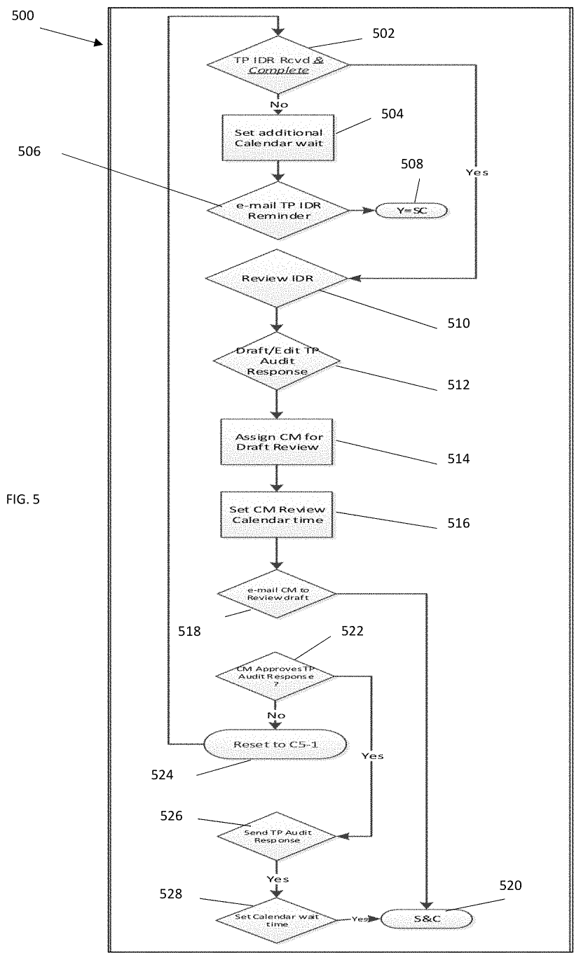

FIG. 5 shows an example embodiment flow chart diagram 500 of a case specialist process.

As shown in the example embodiment, an initial step 502 can be for the system to determine whether a TP IDR has been received and is complete. If not, the system can set an additional calendar wait time in step 504 and then email a TP IDR reminder in step 506 before S&C in step 508. If the system determines that a TP IDR has been received and is complete in step 502, it can review the IDR in step 510, draft and edit a TP audit response in step 512, assign a CM for draft review in step 514, set a CM review calendar time in step 516 and email the CM to review the draft in step 518 before S&C in step 520.

Further, the system can check to see whether a CM has approved a TP audit response in step 522. If not, the system can reset to Case Specialist Step 1 (CS-1) in step 524 and then proceed back to step 502. Otherwise, if yes, the system can determine if it has sent a TP audit response in step 526 and if so, set a calendar wait time in step 528 before S&C in step 520.

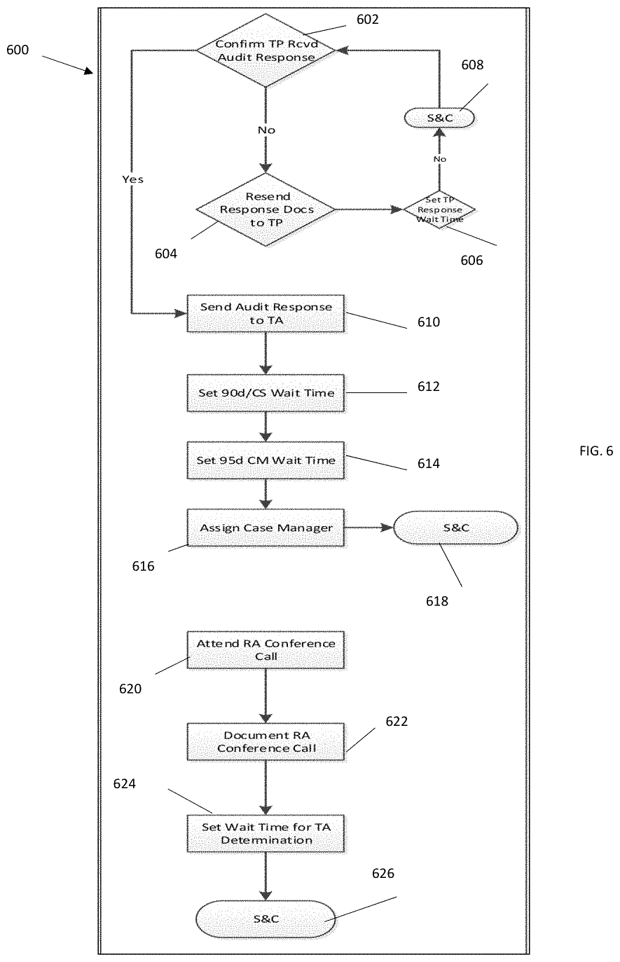

FIG. 6 shows an example embodiment flow chart diagram 600 of another case specialist process.

As shown in the example embodiment, in a first step 602 the system can confirm whether a TP has received an audit response. If not, the system can determine whether to resend response documents to TP in step 604 before determining whether to set a TP response wait time in step 606. If the answer is no, the system can S&C in step 608 before repeating step 602. In step 602 if the answer is yes, the system can proceed to send an audit response to TA in step 610. It can then set a wait time, such as 90 day/CS in step 612, set a 95 day CM wait time in step 614, assign a case manager in step 616, and then S&C in step 618.

Also shown in the example embodiment, the system can provide for the case specialist (CS) to attend a RA conference call in step 620. It can then document the RA conference call in step 622 before setting a wait time for TA determination in step 624 and proceeding to S&C in step 626.

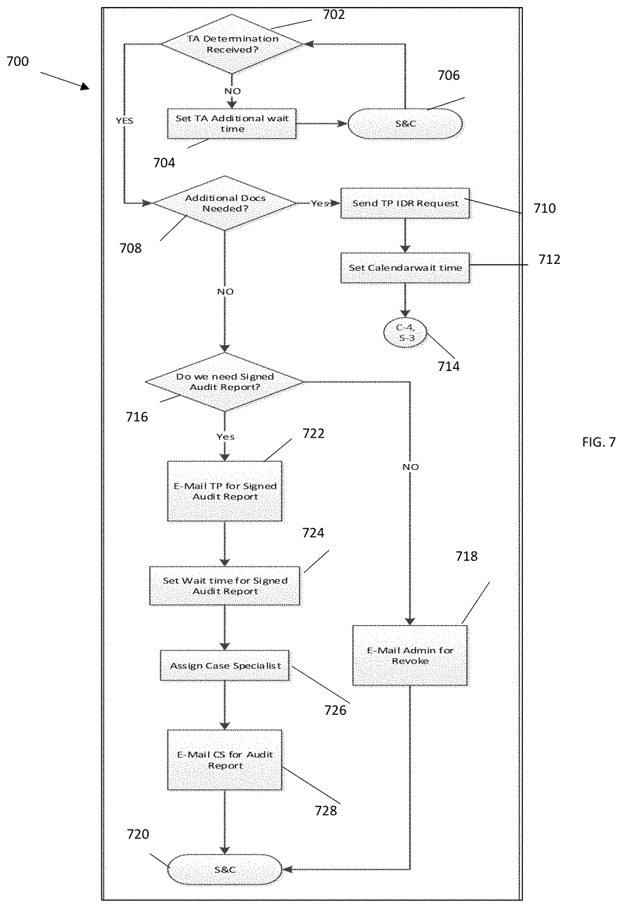

FIG. 7 shows an example embodiment flow chart diagram 700 of another case manager process.

As shown in the example embodiment, the system may first determine whether a TA determination has been received in step 702. If not, the system can set a TA additional wait time in step 704 before S&C in step 706 and repeating step 702. If the determination in step 702 is yes, the system may determine whether additional documents are needed in step 708. If additional documents are needed, the system can send a TP IDR request in step 710 before calendaring a wait time in step 712 and C-4, S-3 in step 714. Otherwise, if no additional documents are needed in step 708, the system can determine whether a signed audit report is needed in step 716. If not, the system can email an administrator for revocation in step 718 before S&C in step 720. Otherwise, the system can email TP for a signed audit report in step 722, set a wait time to receive the signed audit report in step 724, assign a case specialist in step 726, email a CS for audit report in step 728, and then proceed to S&C in step 720.

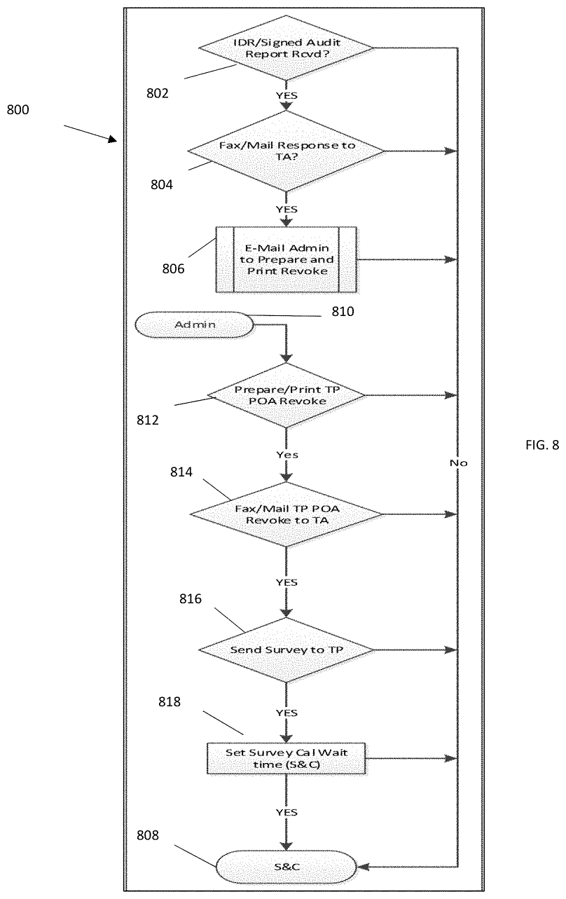

FIG. 8 shows an example embodiment flow chart diagram 800 of another case manager process.

As shown in the example embodiment, an initial step 802 may be to determine whether a signed audit report has been received. If it has, the system may then determine whether to fax or mail a response to TA in step 804. If the answer is yes, the system can proceed to, e.g., email an administrator to prepare and print a revocation in step 806 before S&C in step 808. If the answers to steps 802 or 804 are no, the system can also proceed to S&C in step 808.

Also shown in the example embodiment, the system can determine whether an administrator 810 should proceed to prepare and print a TP POA revocation in step 812. If yes, the system can determine whether to fax or mail the TP POA revocation to TA in step 814. If yes, the system can determine whether to send a survey to TP in step 816. If yes, the system can set a survey calendar wait time in step 818 before proceeding to S&C in step 808. If the answers to steps 812, 814, 816, or 818 are no, the system can also proceed to S&C in step 808.

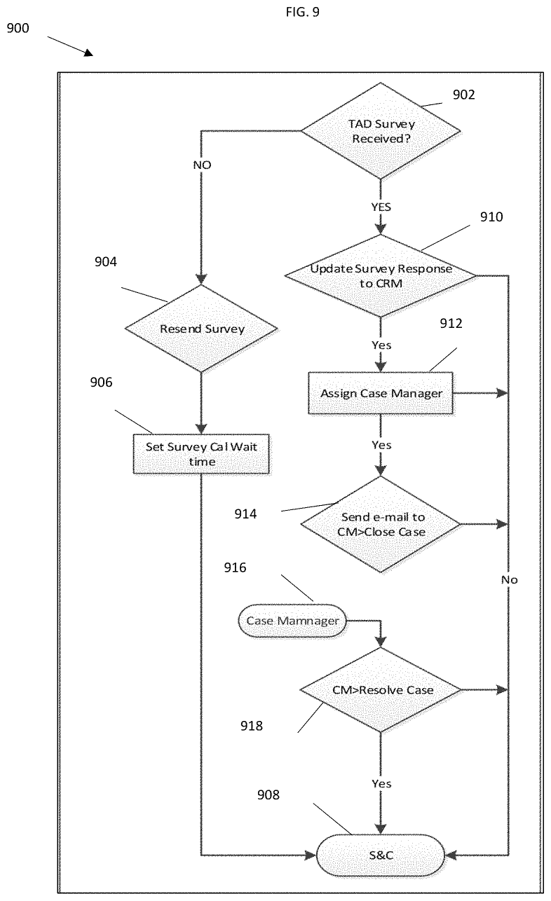

FIG. 9 shows an example embodiment flow chart diagram 900 of another administrator process.

As shown in the example embodiment, the system may initially determine whether a tax audit defense (TAD) survey has been received in step 902. If not, the system may determine whether to resend the survey in step 904, set a survey calendar wait time in step 906 and then proceed to S&C in step 908. If the system determines a TAD survey has been received in step 902, the system can determine whether to update a survey response to CRM in step 910. If the answer is yes, it can assign a case manager in step 912 and then proceed to determine whether to send an email to CM to close the case in step 914. If the answers to any of step 910, 912, or 914 are no, the system can proceed to S&C in step 908. Additionally, a case manager 916 can determine in step 918 whether a CM has resolved the case and then proceed to S&C in step 908.

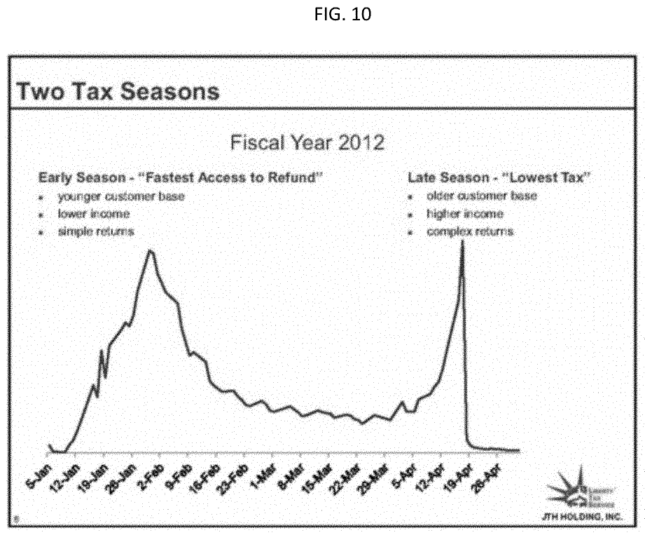

FIG. 10 shows an example embodiment of tax filing volume surges, which in this case is in Fiscal Year 2012. As shown, tax filings are not constant over the entire year. As shown in the example embodiment, based on empirical evidence, it has been shown that there are often multiple “micro” tax seasons within a given year. These can include two between January 1 to mid-April conventional tax season and another in October. To briefly elaborate, in the first several weeks of January, tax filers who expect refunds and tax credits like the Earned Income Tax Credit (“EITC”) create a filing spike. These are typically lower income taxpayers with uncomplicated tax situations filing Form 1040 EZ and 1040A. Then there is a comparative lull until the second two weeks of March and the first two weeks of April when taxpayers who file are those who owe money. These are typically taxpayers with higher adjusted gross incomes, who have more complicated tax situations, who file Form 1040, take itemized deductions, and file with lots of supporting schedules.

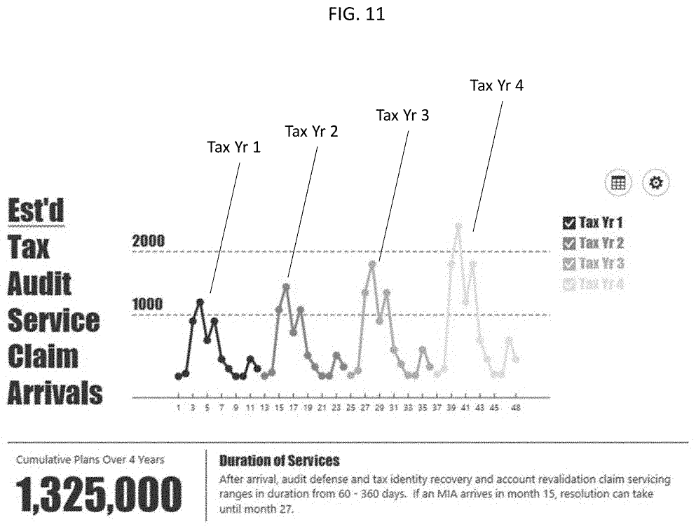

FIG. 11 shows an example embodiment of estimated tax audit service claim arrivals over a four-year period. As shown, tax filings are not constant over the entire year or year over year.

FIG. 12 shows an example embodiment of a traditional organization or professional service firm structure. This can be inefficient and lead to limited throughput and bottlenecks, as described elsewhere herein.

FIG. 13 shows an example embodiment of a traditional LVHV organization or professional service firm structure. This can be inefficient and lead to limited throughput and bottlenecks, with high numbers of higher level managers as described elsewhere herein.

FIG. 14 shows an example embodiment of a mirroring organization or professional service firm structure. This can handle greater case volume but requires a number of independent contractors and leads to operational inefficiency and other problems as described elsewhere herein.

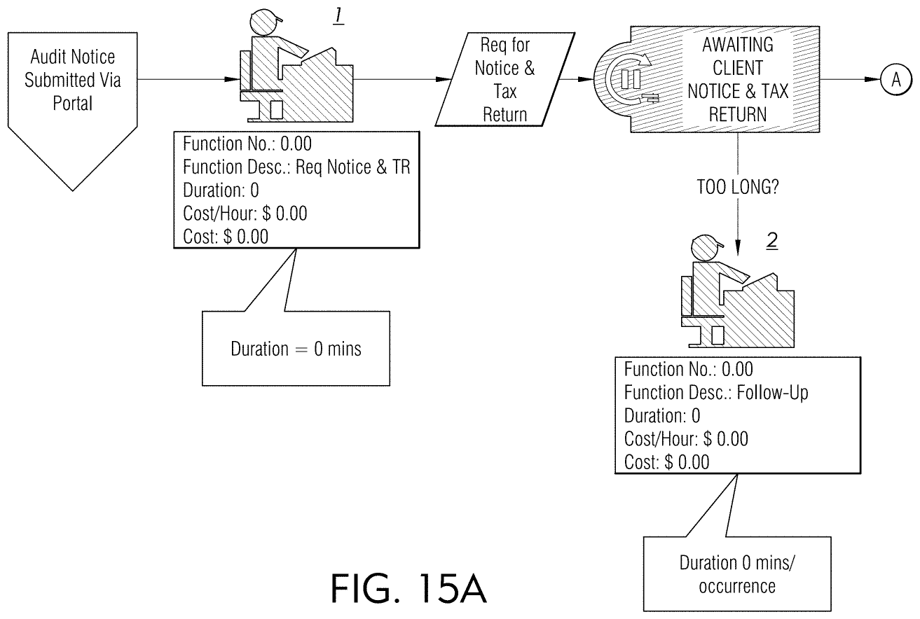

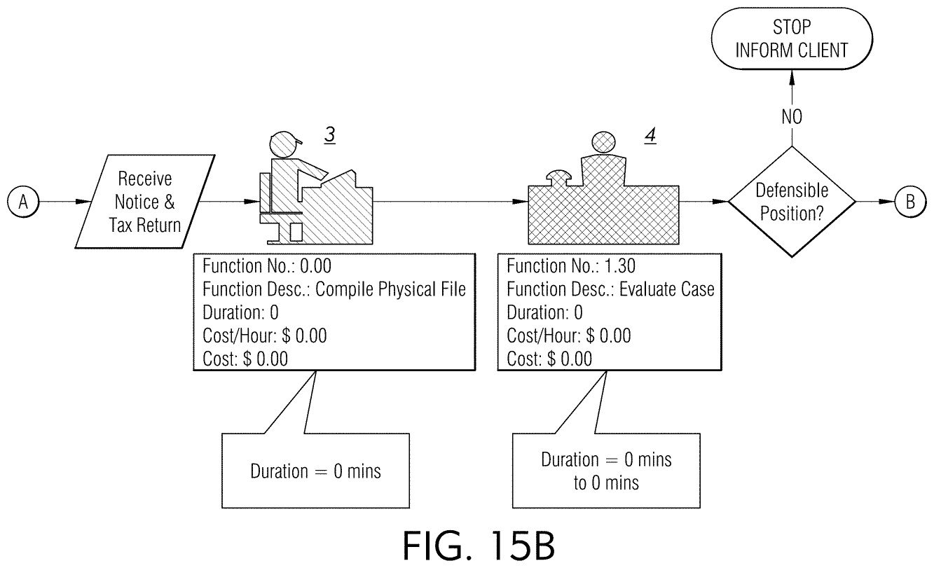

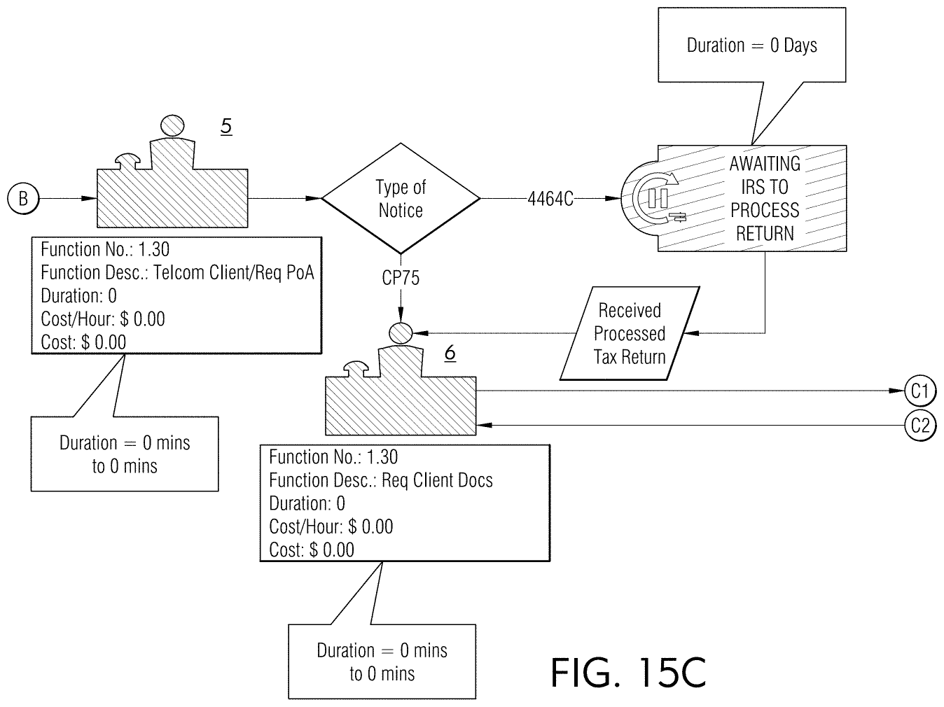

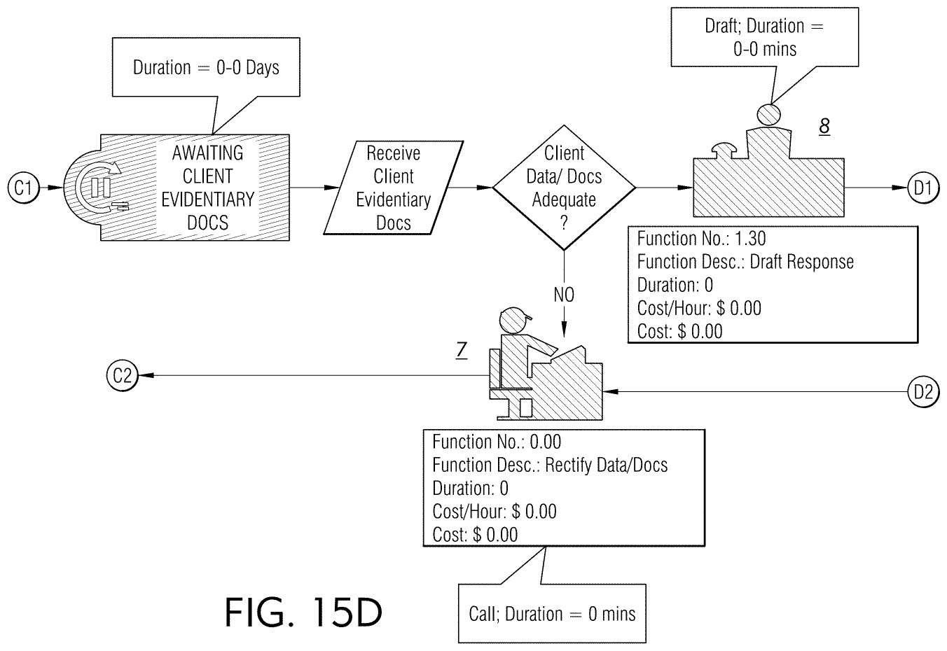

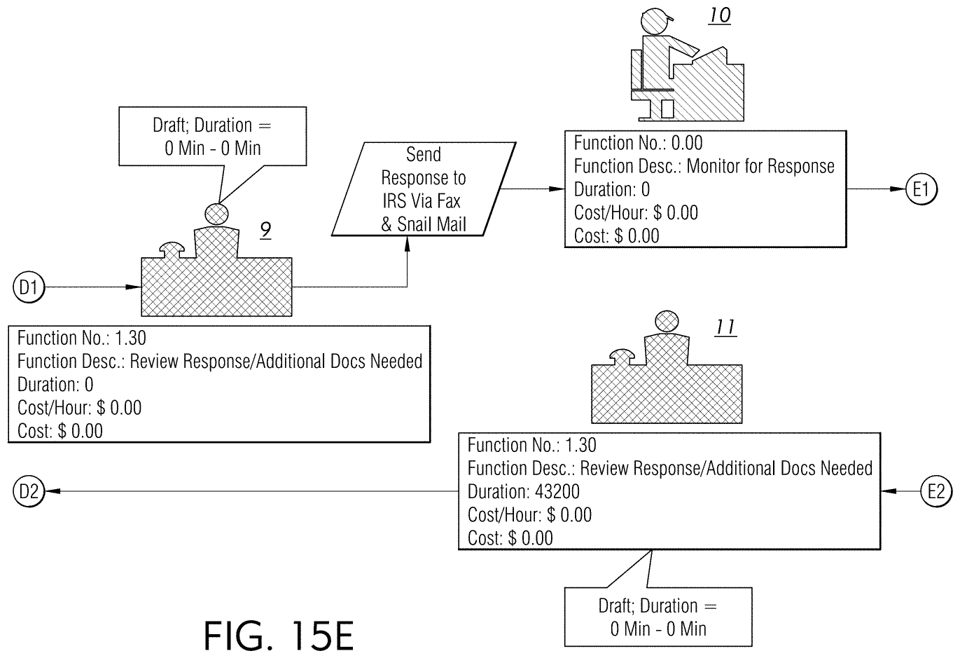

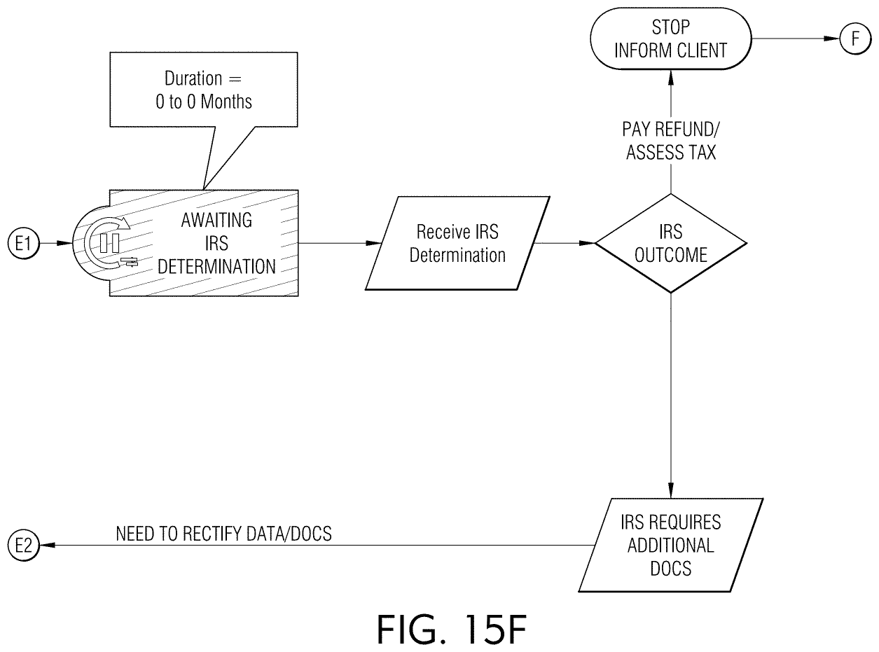

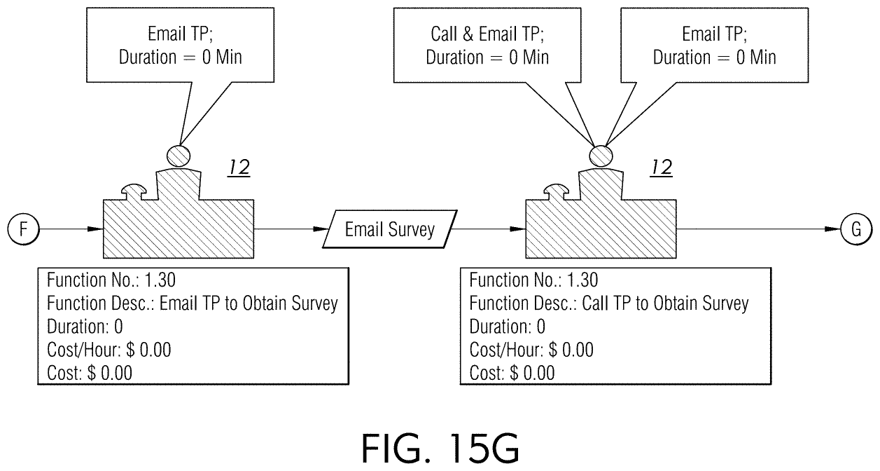

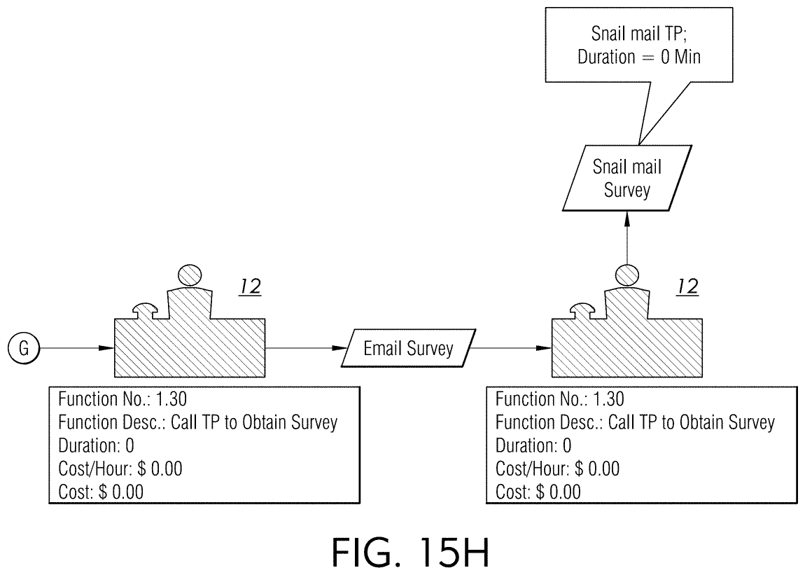

FIGS. 15A-15H show an example embodiment of a high-level diagram with various tasks and procedures for an individual case that are discretized and atomized as described herein. As shown in FIG. 15A, the system may request the audit notice and the tax return from the client. In FIG. 15B, once the system receives the notice and the tax return, it determines whether the audit is defensible. If not defensible, the client is notified, and the process stops. In FIG. 15C, upon determining that the audit is defensible, the system determines the type of notice. The system may also wait for the processed returns from the IRS. Next, as shown in FIG. 15D, the system receives evidentiary documents from the client. The system may loop back to FIG. 15C as needed until sufficient evidentiary documents are received. In FIG. 15E, the system processes the case and sends a response to the IRS. In FIG. 15F, when a determination from the IRS is received, the system may determine that payment should be done, or that further documents are requested from the IRS. If more documents are needed, the process loops back to FIG. 15E then FIG. 15D as needed. When the process is done, for example payment is made, the system may send out survey with via email (FIG. 15G) or by regular mail (FIG. 15H).

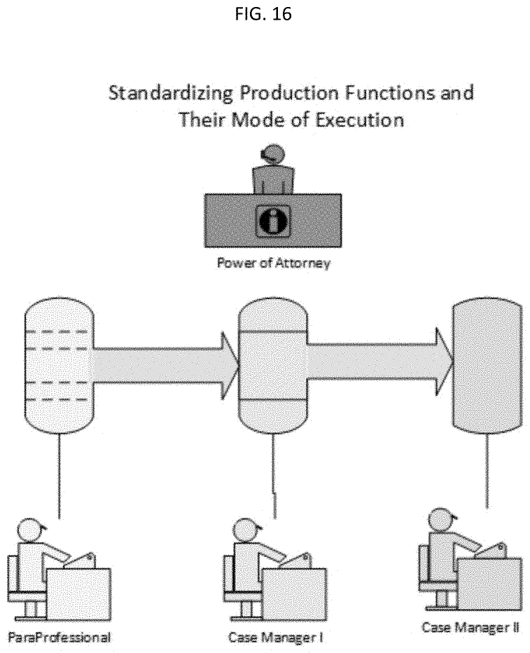

FIG. 16 shows an example embodiment flowchart of a process of standardizing organization for a professional service firm. This can allow for management of a case based on discrete tasks by appropriate personnel at each level, and minimal supervision by human personnel.

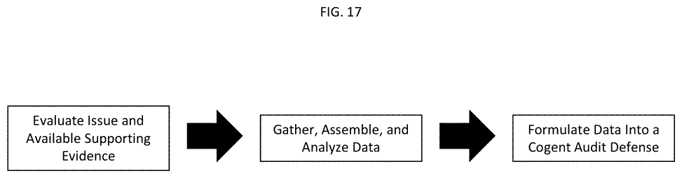

FIG. 17 shows an example embodiment of a high-level diagram flowchart whereby the system can determine an issue and any initial supporting evidence before gathering, assembling, and analyzing related and applicable data, and then formulating the data into a cogent defense as described herein.

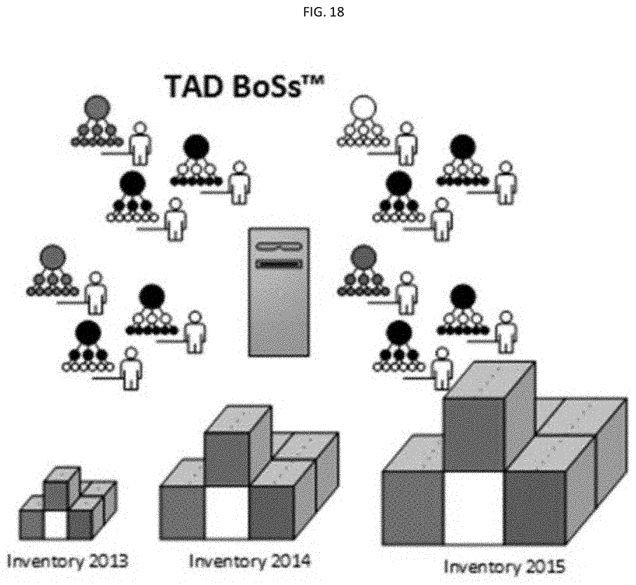

FIG. 18 shows an example embodiment of a high-level diagram providing scalability of processes with minimal requirements for new staff training and hiring as described herein.

In various professional service related industries, clients may be assigned a supervising Power of Attorney, for example a Certified Public Accountant (CPA), Enrolled Agent (EA), Tax Attorney or other individual who is accessible and accountable for case prosecution and outcome. Engagement types for various cases and firm workflow can be distinguished and characterized through the use of formal process flows that detail each functional step that is necessary to effectively manage and complete each case. These can include internal and external communication timing, order of procedural and functional steps, timing and level of staff based on professional experience and qualifications, and others, as appropriate, and required to perform each operation for every case. All of these elements can often be organized into a detailed functional build-up, as a functional “Bill of Service,” for each professional service engagement type.

From the standpoint of a given organizational staff member, process management includes a particular emphasis on the array of tasks required and performance of these tasks in a uniform manner, such that the functions required to advance the cases that are completed in order for a given stage of the array for sustainable profitability. In this manner, the system can absorb wider volume spikes without experiencing crises in staffing and without clients detecting any difference.

From the viewpoint of the client, there is a singular focus on a simplified, linear, step-by-step, and client centric experience. They are often unaware of the meta-organizational level that allows the economies of scale to be realized. Further, clients are often unaware and uncaring as to the flexible production of bi-directional scalability, in the face of volume volatility, as long as there are uniformly high professional standards of services delivered. As such, even clients on the crest of an organization's volume capacity continue to receive excellent service and suffer no delays in the prosecution of their cases.

Technologically implemented processes disclosed herein allow for optimization of mapping in the form of functions, phases, communications, and skill sets. Thus, they provide each variant of a professional service to capture each function, including all operations to be performed in each case phase, for example in tax audit defense and tax identity recovery. Once an operation is complete, the systems, methods, and processes described herein are operable to auto-generate any required internal or external communications and push the case to the next operation, function, or case phase. As such, staff are never required to “reach back” to see where a particular case is during the various processes it may require or where it may have been in the past. To elaborate, if a case is in a particular “task bucket,” it can only be because each of the prerequisite functions have been performed by the appropriate skill set. These systems, methods, and processes improve productivity by acting as an automated task master that propels case flow by automatically pushing each case along to the next station. This can accelerate case flow and save money for clients and the organization by eliminating down or dead time and wasted, repetitive effort from the overall case flow process, thereby allowing fewer people to do more case work. Thus, organizations and their clients are ensured of the uniform application of professional quality by two strategies: 1) breaking down case operations to narrowly defined, discrete “bite-sized” operations with clear objectives and performance criteria; and, 2) enforcing a “not-less-than” skill set rule, enabled by access and function permissions. Cases can then be pushed along the process map and by the system, increasing intra-function speed, efficiency, and quality.

Some standardization that is measured and increased includes: 1) knowing which staff member is logged in and when; 2) what their effective wage and benefit rate is; 3) which client's case the staff member is working on; 4) how long it should take to complete the task, as compared to a standardized range or time value; 5) how long it takes the staff member to complete the task using real-time measurement applied by system timers; and 6) other information. Then the system can generate reports, for every case, for every case type, for every staff member or independent contractor, for every class of staff member or independent contractor, and determine or apply metrics based on how much tasks are anticipated to cost, and how much they are costing the organization.

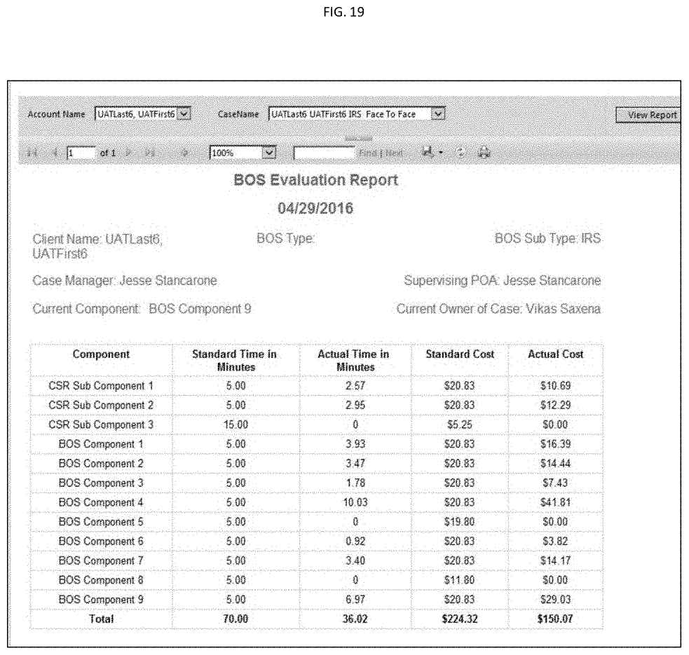

FIG. 19 shows an example embodiment of a user interface diagram. As shown in the example embodiment, a case report can be generated by the system that includes various individual tasks. Each task can be broken down into an expected or standard time to finish, an actual time taken, a standard or expected cost, and an actual cost. As such, case managers, administrators, and other personnel are able to monitor a variety of different metrics for each case.

To elaborate, a “component” can be a bill of service with each task, function, or operation to be performed. “Standard Time in Minutes” can be a normative time to complete the function. “Actual Time in Minutes” can be a real time measured by function, by staff member, by case, or others, as appropriate. A “Standard Cost” can be a cost of the time for the applicable skill set to perform the operation. An “Actual Cost” can be an Actual Time multiplied by the Actual labor rate of the individual performing the task. The system can pull a labor rate cost from a rate table stored in a database that is coupled with a payroll system, in order to improve accuracy across time. In some embodiments, it can take into account, a level or amount of compensation based on raises and promotions, or other changes that occur in the actual staff compensation levels in the real world.

This allows for a professional service firm to generate highly detailed reports about what tasks in particular are critical, their importance in a fixed fee implementation, their fixed product cost, competitive environment, and others. They can be measured in terms of profitability by process or type of audit case, by individual client cases, by departments, by individual staff, and others. They also permit users to experiment with different configurations for workflows, assignments, designations, and others. Providing the ability for users to determine what, if any, difference they may makes in terms of efficiency. Over the long term, these technological tools can make it possible to continually decrease costs without sacrificing quality, thus improving efficiency.

In some embodiments, a backup staffing model is provided. To elaborate, when for prepaid tax audit defense service providers, organizations may handle resultant claims in different ways and not know whether, to what extent, or even how fast the volume of cases may change. An improved Staffing Model, the cadre model and its associated processes, can be automatically or semi-automatically implemented. These can include a “Cadre” or a nucleus or core group of trained personnel able to assume control and to train others. This is the group that knows how everything works and are crack operators. Cadre always have two jobs: 1) do the job; and, 2) train “surge” staff to do the job when the need arises.

In these embodiments, the Cadre system may provide three functions: 1) defend audits; 2) figure out how to make the improve the tools implemented for supporting the effort; and, 3) supervise surge staff defending audits until additional processes are prepared or optimized. Then they can train surge staff to use the system as it is updated.

The improvements of the present disclosure are necessarily rooted in computer-based systems and methods for the optimizing and managing high volume processes having discretized and atomized tasks and components via a network. Additionally, many of the embodiments disclosed herein reflect an inventive concept in the particular arrangement and combination of the devices, components and method steps utilized for the collection, verification, creation and modification of digital data for the optimizing and managing high volume processes having discretized and atomized tasks and components via a network. In some embodiments, collected data are first verified and/or validated.

As used herein and in the appended claims, the singular forms “a”, “an”, and “the” include plural referents unless the context clearly dictates otherwise.

In the foregoing description and in the figures, like elements are identified with like reference numerals. The use of “e.g.,” “etc,” and “or” indicates non-exclusive alternatives without limitation, unless otherwise noted. The use of “including” or “include” means “including, but not limited to,” or “include, but not limited to,” unless otherwise noted.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

The publications discussed herein are provided solely for their disclosure prior to the filing date of the present application. Nothing herein is to be construed as an admission that the present disclosure is not entitled to antedate such publication by virtue of prior disclosure. Further, the dates of publication provided may be different from the actual publication dates which may need to be independently confirmed. Additionally, all publications discussed herein are hereby incorporated by reference in their entirety.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together, or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

1. A server-based system for optimizing and managing high volume processes having discretized and atomized tasks and components over a network, comprising:
a management optimization server, communicatively coupled to the network, comprising:
at least one database, stored in non-transitory computer readable memory;
at least one timer; and
at least one server processor,
a user device, communicatively coupled to the network, comprising:
non-transitory computer readable memory;
at least one user device processor;
a user interface display;
a user interface input;
wherein the at least one user device processor is configured to log a selected user into a server based portal via the network, receive, from the management optimization server via the network, at least one task instruction for a task, cause the user device to display one or more steps related to the task, track user input entered by the selected user via the user interface input, and transmit at least one completed task result to the management optimization server via the network; and
wherein the at least one server processor is configured to store a series of tasks required for completion of a plurality of cases in the at least one database, determine a current task for completion for a selected case of the plurality of cases based on a case history profile associated with the selected case and stored in the at least one database, transmit at least one task instruction for the selected case to the user device based on the selected user's credentials, monitor a time for completion of the current task using the at least one timer, and upon receiving the completed task result, update the case history profile to reflect the status of the current task as completed.

2. The server-based system for optimizing and managing high volume processes having discretized and atomized tasks and components over a network of claim 1, wherein the at least one server processor is further configured to collect data for a type of task for a predetermined period of time.

3. The server-based system for optimizing and managing high volume processes having discretized and atomized tasks and components over a network of claim 2, wherein the predetermined period of time is one of times of day, and days of weeks.

4. The server-based system for optimizing and managing high volume processes having discretized and atomized tasks and components over a network of claim 2, wherein the at least one server processor is further configured to calculate statistical metrics from the collected data.

5. The server-based system for optimizing and managing high volume processes having discretized and atomized tasks and components over a network of claim 4, wherein the statistical metrics include at least one of mean, median, maximum, minimum, and standard deviation.

6. The server-based system for optimizing and managing high volume processes having discretized and atomized tasks and components over a network of claim 1, wherein the at least one server processor is further configured to set a target for the current task.

7. The server-based system for optimizing and managing high volume processes having discretized and atomized tasks and components over a network of claim 1, wherein the current task is determined in a particular order.

8. The server-based system for optimizing and managing high volume processes having discretized and atomized tasks and components over a network of claim 1, wherein the current task is determined based on one or more triggers.

9. The server-based system for optimizing and managing high volume processes having discretized and atomized tasks and components over a network of claim 1, wherein the processes comprise professional services.

10. The server-based system for optimizing and managing high volume processes having discretized and atomized tasks and components over a network of claim 9, wherein the selected user is an employee of the professional services.

11. A computer-based method for optimizing and managing high volume processes having discretized and atomized tasks and components over a network, comprising:
at a user device:
logging a selected user into a server based portal via a network,
receiving, from a management optimization server via the network, at least one task instruction for a task,
causing the user device to display one or more steps related to the task, tracking user input entered by the selected user, and
transmitting at least one completed task result to the management optimization server via the network; and
at a management optimization server:
storing a series of tasks required for completion of a plurality of cases in at least one database,
determining a current task for completion for a selected case of the plurality of cases based on a case history profile associated with the selected case and stored in the at least one database,
transmitting at least one task instruction for the selected case to the user device based on the selected user's credentials,
monitoring a time for completion of the current task using at least one timer, and
upon receiving the completed task result, updating the case history profile to reflect the status of the current task as completed.

12. A computer-based method for optimizing and managing high volume processes having discretized and atomized tasks and components over a network of claim 11, wherein management optimization server further collects data for a type of task for a predetermined period of time.

13. A computer-based method for optimizing and managing high volume processes having discretized and atomized tasks and components over a network of claim 12, wherein the predetermined period of time is one of times of day, and days of weeks.

14. A computer-based method for optimizing and managing high volume processes having discretized and atomized tasks and components over a network of claim 12, wherein the management optimization server further calculates statistical metrics from the collected data.

15. A computer-based method for optimizing and managing high volume processes having discretized and atomized tasks and components over a network of claim 14, wherein the statistical metrics include at least one of mean, median, maximum, minimum, and standard deviation.

16. A computer-based method for optimizing and managing high volume processes having discretized and atomized tasks and components over a network of claim 11, wherein management optimization server sets a target for the current task.

17. A computer-based method for optimizing and managing high volume processes having discretized and atomized tasks and components over a network of claim 11, wherein current task is determined in a particular order.

18. A computer-based method for optimizing and managing high volume processes having discretized and atomized tasks and components over a network of claim 11, wherein the current task is determined based on one or more triggers.

19. A computer-based method for optimizing and managing high volume processes having discretized and atomized tasks and components over a network of claim 11, wherein the processes comprise professional services.

20. A computer-based method for optimizing and managing high volume processes having discretized and atomized tasks and components over a network of claim 11, wherein the selected user is an employee of the professional services.
